(19) United States
(12) Patent Application Publication
(10) Pub. No.: US 2013/0137453 A1
(43) Pub. Date: May 30, 2013

(54) TERMINAL CONTROL APPARATUS, MOBILE COMMUNICATION TERMINAL, METHOD FOR CONTROLLING TERMINAL, AND COMMUNICATION SYSTEM

(71) Applicant: Fujitsu Limited, Kawasaki-shi (JP)

(72) Inventor: Kazuaki Ando, Shibuya (JP)

(73) Assignee: FUJITSU LIMITED, Kawasaki-shi (JP)

(21) Appl. No.: 13/627,011

(22) Filed: Sep. 26, 2012

(30) Foreign Application Priority Data
Nov. 25, 2011 (JP) 2011-258165

(51) Int. Cl. H04W 24/00

(52) U.S. Cl. 455/456.1

(57) ABSTRACT

A terminal control apparatus that controls a mobile communication terminal that receives wireless signals at periodical reception times, includes a memory and a processor that estimates a position of the mobile communication terminal at each time including the periodical reception times based on positions identified by the wireless signals, judging whether at least one of the estimated positions is included in a dead zone, based on information indicating the dead zone, calculates, when judged that at least one of the estimated positions is included in the dead zone, at least one time that comes before a time at which the mobile communication terminal enters the dead zone and that comes after one of the periodical reception times before the time at which the mobile communication terminal enters the dead zone, and controls the mobile communication terminal so that the mobile communication terminal receives a wireless signal at the calculated time.

### CROSS-REFERENCE TO RELATED APPLICATION

This application is based upon and claims the benefit of priority of the prior Japanese Patent Application No. 2011-258165, filed on Nov. 25, 2011, the entire contents of which are incorporated herein by reference.

### FIELD

The embodiments discussed herein are related to a terminal control apparatus, a mobile communication terminal, a method for controlling a terminal, and a communication system.

### BACKGROUND

A method for estimating the position of a mobile communication terminal used in a movable body such as a train is known (for example, refer to Japanese Laid-open Patent Publication No. 2010-81551). In this method, for example, the mobile communication terminal periodically receives wireless signals from a Global Positioning System (GPS) satellite to obtain positional information, and transmits the obtained positional information and times at which the positional information has been obtained to a server. The server calculates moving speed from the positional information and the times at which the positional information has been obtained transmitted from the mobile communication terminal and assumes that the mobile communication terminal moves in accordance with route information held by the server, in order to estimate the positions of the mobile communication terminal at times when the mobile communication terminal does not obtain the positional information.

In addition, with respect to the estimation of the position of the mobile communication terminal, a technique is known in which out-of-service areas are predicted and the timing at which data is transmitted from a server to a movable body is changed (for example, refer to Japanese Laid-open Patent Publication No. 2001-27538). In addition, a technique is known in which when it is difficult to receive a GPS signal in a tunnel, navigation is realized using speed calculated from a GPS signal obtained immediately before the mobile communication terminal enters the tunnel and speed calculated from an image captured by an on-vehicle camera (Japanese Laid-open Patent Publication No. 2009-168614).

In addition, a technique is known in which estimation of the position of a vehicle is performed based on GPS information obtained immediately before the vehicle enters a tunnel and standard traveling speed at a guide point inside the tunnel, and the position of a speed measuring apparatus inside the tunnel or the like is notified (for example, refer to Japanese Laid-open Patent Publication No. 2011-39038). In addition, a technique is known in which weather information around the end of a tunnel is received in advance before the mobile communication terminal enters the tunnel and driving caution information to be paid attention to in terms of the weather information around the end of the tunnel is notified (for example, refer to Japanese Laid-open Patent Publication No. 2008-232952).

### SUMMARY

According to an aspect of the invention, a terminal control apparatus that controls a mobile communication terminal that receives, at periodical reception times, wireless signals for enabling identification of positions of the mobile communication terminal, the terminal control apparatus includes a memory, and a processor that, when executing a procedure stored in the memory, estimates a position of the mobile communication terminal at each time including the periodical reception times based on the positions identified by the wireless signals received by the mobile communication terminal, judges whether or not at least one of the estimated positions at the periodical reception times is included in a dead zone, in which the mobile communication terminal does not receive the wireless signals, based on information indicating the dead zone, calculates, when judged that at least one of the positions at the periodical reception times is included in the dead zone, based on the estimated position at each time, at least one time that comes before a time at which the mobile communication terminal enters the dead zone and that comes after one of the periodical reception times before the time at which the mobile communication terminal enters the dead zone, and controls the mobile communication terminal so that the mobile communication terminal receives a wireless signal at the calculated time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a state before control executed by a terminal control apparatus according to a first embodiment;

FIG. 1B is a diagram illustrating a first example of the control executed by the terminal control apparatus according to the first embodiment;

FIG. 1C is a diagram illustrating a second example of the control executed by the terminal control apparatus according to the first embodiment;

FIG. 1D is a diagram illustrating a third example of the control executed by the terminal control apparatus according to the first embodiment;

FIG. 2 is a diagram illustrating an example of a communication system;

FIG. 3 is a diagram illustrating an example of the hardware configuration of a server;

FIG. 4 is a diagram illustrating an example of the hardware configuration of a mobile communication terminal;

FIG. 5 is a diagram illustrating an example of the functional configuration of the server according to the first embodiment;

FIG. 6 is a diagram illustrating an example of an operation database (DB);

FIG. 7 is a diagram illustrating an example of a route DB;

FIG. 8 is a diagram illustrating an out-of-service DB;

FIG. 9 is a diagram illustrating an example of the functional configuration of the mobile communication terminal according to the first embodiment;

FIG. 10 is a flowchart illustrating an example of the operation of the server according to the first embodiment;

FIG. 11 is a flowchart illustrating an example of the operation of the mobile communication terminal according to the first embodiment;

FIG. 12 is a flowchart illustrating an example of the operation of a server according to a second embodiment;

FIG. 13 is a flowchart illustrating an example of a mobile communication terminal according to the second embodiment;

FIG. 14 is a diagram illustrating an example of the functional configuration of a mobile communication terminal according to a third embodiment;

FIG. 15 is a flowchart illustrating an example of an operation for estimating a position executed by the mobile communication terminal according to the third embodiment;

FIG. 16 is a flowchart illustrating an example of an operation for receiving a GPS signal executed by the mobile communication terminal according to the third embodiment;

FIG. 17 is a diagram illustrating an example of the functional configuration of a server according to a fourth embodiment; and

FIG. 18 is a diagram illustrating an example of an out-of-service/instable DB according to the fourth embodiment.

### DESCRIPTION OF EMBODIMENTS

A terminal control apparatus, a mobile communication terminal, a method for controlling a terminal, and a communication system according to embodiments will be described in detail hereinafter with reference to the accompanying drawings.

While inventing the present embodiments, observations were made regarding a related art. Such observations include the following, for example.

In techniques of the related art for estimating the position of a mobile communication terminal, if a mobile communication terminal that receives GPS signals at periodical reception times passes through a dead zone such as a tunnel, a period for which a GPS signal is not received becomes long, thereby decreasing the accuracy of estimation of the position of the mobile communication terminal.

According to the following embodiments, a technique for improving the accuracy of position estimation more accurately may be provided.

### First Embodiment

### Example of Control Executed by Terminal Control Apparatus According to First Embodiment

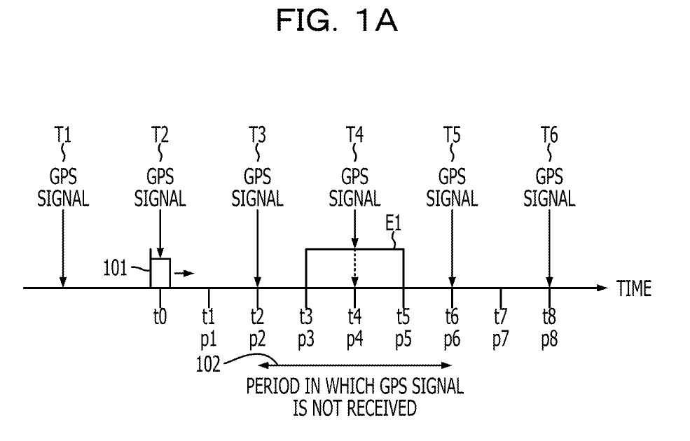

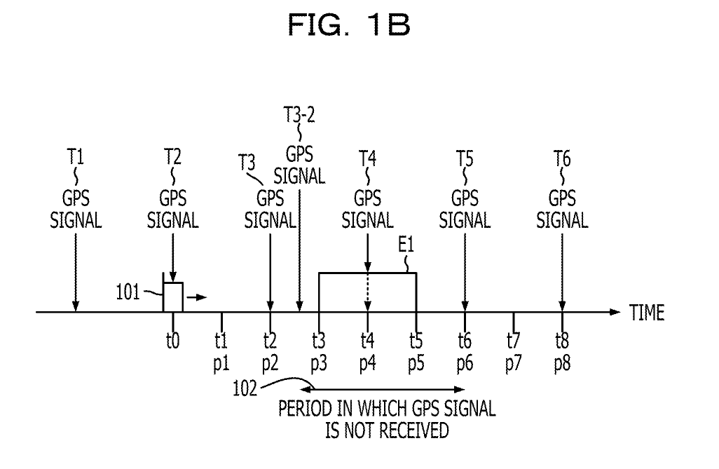

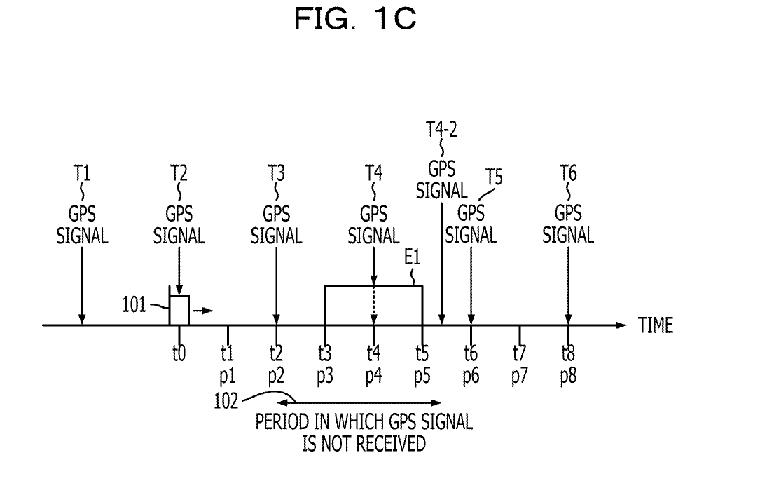

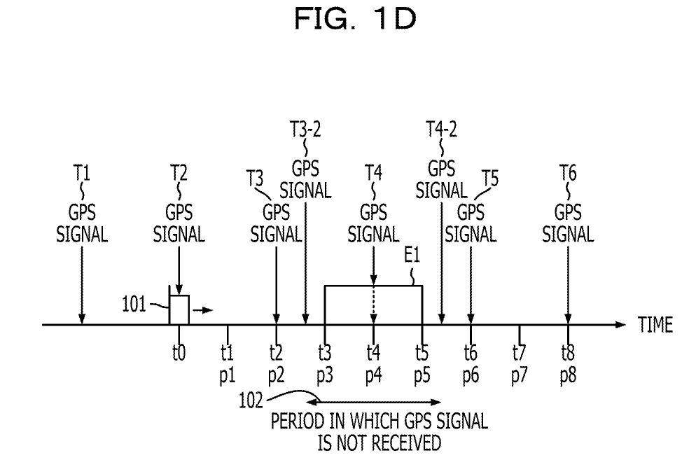

FIG. 1A is a diagram illustrating an example of a state before control executed by a terminal control apparatus according to a first embodiment. In FIG. 1A, the horizontal axis represents time. A mobile communication terminal 101 receives wireless signals that enable identification of the position thereof (the main terminal) at periodical reception times T1 to T6. A wireless signal is, for example, a GPS signal transmitted from a GPS satellite. However, a wireless signal is not limited to a GPS signal insofar as the wireless signal is a wireless signal that enables identification of the current position of the mobile communication terminal 101. The reception times T1 to T6 come, for example, at 5-minute intervals.

The terminal control apparatus according to the first embodiment (hereinafter also referred to simply as the “terminal control apparatus”) is a control apparatus that controls the reception times at which the mobile communication terminal 101 receives GPS signals. The terminal control apparatus can obtain, from, for example, transmission by the mobile communication terminal 101, the periodical reception times, at which the mobile communication terminal 101 receives the GPS signals.

A time t0 is the current time. Times t1 to t8 are future times. The times t0 to t8 come, for example, at 5-minute intervals. A dead zone E1 indicates a zone in which the mobile communication terminal 101 does not receive a GPS signal, and the dead zone E1 is associated with a period over which the mobile communication terminal 101 passes therethrough. The dead zone E1 is, for example, a zone in which a wireless signal transmitted from the outside is not received, such as a tunnel. In the example illustrated in FIG. 1A, the mobile communication terminal 101 enters the dead zone E1 at the time t3. In addition, the mobile communication terminal 101 exits from the dead zone E1 at the time t5.

Upon receiving each GPS signal, for example, the mobile communication terminal 101 transmits positional information indicating a position identified by the received GPS signal to the terminal control apparatus. The terminal control apparatus estimates, based on the positional information received from the mobile communication terminal 101, the positions of the mobile communication terminal 101 at times other than positions identified by the positional information. In the example illustrated in FIG. 1A, for example, the times at which the positions of the mobile communication terminal 101 are not identified by the positional information are the times t1, t3, t5, and t7.

In doing so, even if the intervals at which the mobile communication terminal 101 receives the GPS signals are long (for example, 5 minutes), the mobile communication terminal 101 can estimate the positions of the mobile communication terminal 101 at times when the mobile communication terminal 101 does not receive GPS signals. Therefore, the number of times that the mobile communication terminal 101 executes an operation for receiving a GPS signal can be decreased, thereby suppressing the power consumption of the mobile communication terminal 101.

However, the mobile communication terminal 101 does not receive a GPS signal during the times t3 to t5, over which the mobile communication terminal 101 passes through the dead zone E1. A non-reception period 102 is a period for which the mobile communication terminal 101 does not receive a GPS signal. In the example illustrated in FIG. 1A, among the reception times T1 to T6, the beginning of the non-reception period 102 is the reception time T3, which is immediately before the mobile communication terminal 101 enters the dead zone E1. Among the reception times T1 to T6, the end of the non-reception period 102 is the reception time T5, which is immediately after the mobile communication terminal 101 exits from the dead zone E1. Therefore, the length of the non-reception period 102 is twice the intervals of the reception times T1 to T6 (for example, 10 minutes).

FIG. 1B is a diagram illustrating a first example of the control executed by the terminal control apparatus according to the first embodiment. In FIG. 1B, the same elements as those illustrated in FIG. 1A are given the same reference numerals, and description thereof is omitted. As illustrated in FIG. 1B, the terminal control apparatus estimates positions p1 to p8 of the mobile communication terminal 101 at the times t1 to t8, respectively. More specifically, the terminal control apparatus obtains, from the mobile communication terminal 101, the positional information based on the GPS signals received by the mobile communication terminal 101, and estimates the positions p1 to p8 at the times t1 to t8, respectively, based on the obtained positional information.

The positions p1 to p8 at the times t1 to t8, respectively, estimated by the terminal control apparatus include the positions p2, p4, p6, and p8 of the mobile communication terminal 101 at the reception times T1 to T6. The terminal control apparatus judges whether or not at least any of the estimated positions p2, p4, p6, and p8 of the mobile communication terminal 101 at the reception times T3 to T6, respectively, is included in the dead zone E1 based on information indicating dead zones including the dead zone E1. In the example illustrated in FIG. 1B, it is judged that the position p4 of the mobile communication terminal 101 at the reception time T4 is included in the dead zone E1.

In addition, if it is judged that at least any of the positions p2, p4, p6, and p8 is included in the dead zone E1, the terminal control apparatus calculates an additional reception time. The additional reception time is, for example, at least one time that before the time t3 (entrance time), at which the mobile communication terminal 101 enters the dead zone E1 and that comes after the reception time T3, which is immediately before the time t3 among the reception times T1 to T6.

In the example illustrated in FIG. 1B, the terminal control apparatus is assumed to calculate a time T3-2 that comes between the reception time T3 and the time t3. The terminal control apparatus controls the mobile communication terminal 101 such that the mobile communication terminal 101 receives a GPS signal at the calculated time T3-2. More specifically, the terminal control apparatus controls the mobile communication terminal 101 by transmitting a reception control signal including the time T3-2 to the mobile communication terminal 101.

In the example illustrated in FIG. 1B, the beginning of the non-reception period 102 is the time T3-2 between the reception time T3 and the time t3. Among the reception times T1 to T6, the end of the non-reception period 102 is the reception time T5, which is immediately after the mobile communication terminal 101 exits from the dead zone E1. As illustrated in FIGS. 1A and 1B, by executing the control using the terminal control apparatus, the non-reception period 102 for which the mobile communication terminal 101 does not receive a GPS signal can be shortened.

Alternatively, the terminal control apparatus may calculate a time that comes a first certain period of time or more before the time t3. In doing so, for example, an additional reception time can be calculated at which reception of a GPS signal can be completed before the mobile communication terminal 101 enters the dead zone E1.

Alternatively, the terminal control apparatus may calculate a time that comes a second certain period of time or more after the reception time T3. In doing so, it is possible to cause a period between the reception of a GPS signal at the reception time T3 and the reception of a GPS signal at the additional reception time to be longer than the second certain period of time. Therefore, the power consumption of the mobile communication terminal 101 can be suppressed.

Alternatively, when the difference between the reception time T3 and the time t3 is smaller than or equal to a certain period of time, the terminal control apparatus may keep the mobile communication terminal 101 from receiving a wireless signal at the additional reception time. In doing so, a period between a periodical reception time and the additional reception time becomes short, and therefore it is possible to avoid reception of a GPS signal at the additional reception time when an effect of improving the accuracy of position estimation is small, thereby suppressing the power consumption of the mobile communication terminal 101.

Alternatively, although a case in which whether or not at least any of the positions p2, p4, p6, and p8 is included in the dead zone E1 is judged has been described, the present disclosure is not limited to such a judgment. For example, the terminal control apparatus may judge whether or not a position at one of the periodical reception times T1 to T6 immediately after the current time (next reception time) is included in the dead zone E1.

In the example illustrated in FIG. 1B, after the reception time T3, it is judged that the position p4 at the next reception time T4 is included in the dead zone E1. Thus, by judging whether or not the position at the next reception time is included in the dead zone E1, the judgment is made based on a position estimated at a time later than, for example, a judgment as to whether or not a position at a second reception time from the current time is included in the dead zone E1. Therefore, it is possible to judge whether or not the positions at the periodical reception times are included in the dead zone E1 more accurately. In addition, since an additional reception time is calculated based on a position estimated at a later point of time, it is possible to calculate the additional reception time for improving the accuracy of position estimation more accurately.

FIG. 1C is a diagram illustrating a second example of the control executed by the terminal control apparatus according to the first embodiment. In FIG. 1C, the same elements as those illustrated in FIG. 1B are given the same reference numerals, and description thereof is omitted. The terminal control apparatus may calculate at least one time that comes after the time t5 (a first time), at which the mobile communication terminal 101 exits from the detected dead zone E1, and that comes before the reception time T5 (a second time), which is immediately after the time t5 among the reception times T3 to T6.

In the example illustrated in FIG. 1C, the terminal control apparatus is assumed to calculate a time T4-2 that comes between the time t5 and the reception time T5. The terminal control apparatus controls the mobile communication terminal 101 such that the mobile communication terminal 101 receives a GPS signal at the calculated time T4-2. More specifically, the terminal control apparatus controls the mobile communication terminal 101 by transmitting a reception control signal including the time T4-2 to the mobile communication terminal 101.

In the example illustrated in FIG. 1C, among the reception times T1 to T6, the beginning of the non-reception period 102 is the reception time T3, which is immediately before the mobile communication terminal 101 enters the dead zone E1. The end of the non-reception period 102 is the time T4-2 between the time t5 and the reception time T5. As illustrated in FIGS. 1A and 1C, by executing the control using the terminal control apparatus, the non-reception period 102 for which the mobile communication terminal 101 does not receive a GPS signal can be shortened.

Alternatively, the terminal control apparatus may calculate a time that comes a third certain period of time or more before the reception time T5, which is immediately after the time t5 (exit time). In doing so, for example, it is possible to cause a period between the reception of a GPS signal at the additional reception time and the reception of a GPS signal at the reception time T5 to be longer than the third certain period of time. Therefore, the power consumption of the mobile communication terminal 101 can be suppressed.

FIG. 1D is a diagram illustrating a third example of the control executed by the terminal control apparatus according to the first embodiment. In FIG. 1D, the same elements as those illustrated in FIG. 1B or 1C are given the same reference numerals, and description thereof is omitted. The terminal control apparatus may calculate both the time T3-2 illustrated in FIG. 1B and the time T4-2 illustrated in FIG. 1C.

The terminal control apparatus controls the mobile communication terminal 101 such that the mobile communication terminal 101 receives GPS signals at the calculated times T3-2 and T4-2. More specifically, the terminal control apparatus controls the mobile communication terminal 101 by transmitting a reception control signal including the times T3-2 and T4-2 to the mobile communication terminal 101.

In the example illustrated in FIG. 1D, the beginning of the non-reception period 102 is the time T3-2. The end of the non-reception period 102 is the time T4-2. As illustrated in FIGS. 1A to 1D, by executing the control illustrated in FIG. 1D, the non-reception period 102 for which the mobile communication terminal 101 does not receive a GPS signal can be further shortened.

Communication System

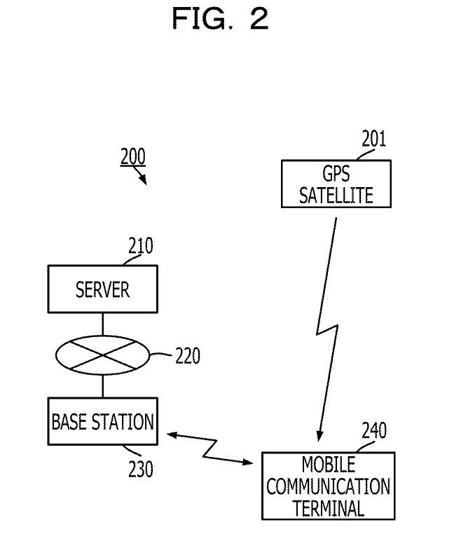

FIG. 2 is a diagram illustrating an example of a communication system. As illustrated in FIG. 2, a communication system 200 includes a server 210, a network 220, a base station 230, and a mobile communication terminal 240. The server 210 is connected to the base station 230 through the network 220 and communicates with the mobile communication terminal 240 through the mobile communication terminal 240. The terminal control apparatus according to the first embodiment may be, for example, adopted as the server 210.

By transmitting a reception control signal to the mobile communication terminal 240 through the base station 230, the server 210 controls a reception time at which the mobile communication terminal 240 receives a GPS signal. In addition, the server 210 receives, from the mobile communication terminal 240 through the base station 230, positional information based on the GPS signal received from the GPS satellite 201. The network 220 is, for example, a mobile communication network. The base station 230 relays communication between the server 210 and the mobile communication terminal 240 by wirelessly communicating with the mobile communication terminal 240.

The mobile communication terminal 240 is a mobile communication terminal to be controlled by the terminal control apparatus and has a configuration corresponding to that of the mobile communication terminal 101 illustrated in FIGS. 1A to 1D. The mobile communication terminal 240 receives GPS signals from the GPS satellite 201 at periodical reception times while, for example, a user who owns the mobile communication terminal 240 moves using a movable body such as a train.

In addition to the periodical reception times, the mobile communication terminal 240 receives a GPS signal from the GPS satellite 201 also at an additional reception time specified by a reception control signal received from the server 210 through the base station 230. In addition, upon receiving each GPS signal, the mobile communication terminal 240 transmits positional information based on the received GPS signal to the server 210 through the base station 230.

The server 210 estimates the position of the mobile communication terminal 240 based on the positional information from the mobile communication terminal 240. For example, the server 210 estimates the position of the mobile communication terminal 240 in the future using a database (a timetable or the like) relating to information regarding the operation of the train in which the mobile communication terminal 240 is used. The server 210 then provides a service based on a result of the position estimation executed by the mobile communication terminal 240.

For example, when the mobile communication terminal 240 is to download data, the server 210 may execute control such that the mobile communication terminal 240 does not download the data in an area in which communication conditions are insufficient and the mobile communication terminal 240 downloads the data in an area in which the communication conditions are sufficient. More specifically, the server 210 calculates a time at which the mobile communication terminal 240 enters an area in which the communication conditions are sufficient based on the result of the position estimation executed by the mobile communication terminal 240 and controls the mobile communication terminal 240 in such a way as to keep the mobile communication terminal 240 from downloading the data until the calculated time. The control for keeping the mobile communication terminal 240 from downloading the data can be executed by transmitting a control signal to the mobile communication terminal 240 through the base station 230.

Alternatively, the server 210 may, for example, provide a service for transmitting information relating to the estimated position of the mobile communication terminal 240 to the mobile communication terminal 240. However, services based on the result of the position estimation executed by the mobile communication terminal 240 are not limited to these services, and various services may be adopted.

Alternatively, the server 210 does not provide a service based on the result of the position estimation executed by the mobile communication terminal 240, and the mobile communication terminal 240 may estimate the current position based on the received GPS signal and execute processing based on a result of the estimation. For example, when the mobile communication terminal 240 is to download data, the mobile communication terminal 240 may execute processing for keeping the mobile communication terminal 240 from downloading the data until the mobile communication terminal 240 enters an area in which the communication conditions are sufficient.

In addition, when positions at which the mobile communication terminal 240 periodically receives GPS signals overlap a dead zone in which the mobile communication terminal 240 does not receive a GPS signal such as a tunnel, the server 210 transmits an additional reception time that comes before the mobile communication terminal 240 enters the dead zone to the mobile communication terminal 240. In addition to the periodical reception times, the mobile communication terminal 240 receives a GPS signal also at the additional reception time transmitted from the server 210. In doing so, a period for which the mobile communication terminal 240 does not receive a GPS signal while the mobile communication terminal 240 passes through the dead zone can be shortened, thereby improving the accuracy of the position estimation executed by the mobile communication terminal 240.

Hardware Configuration of Server

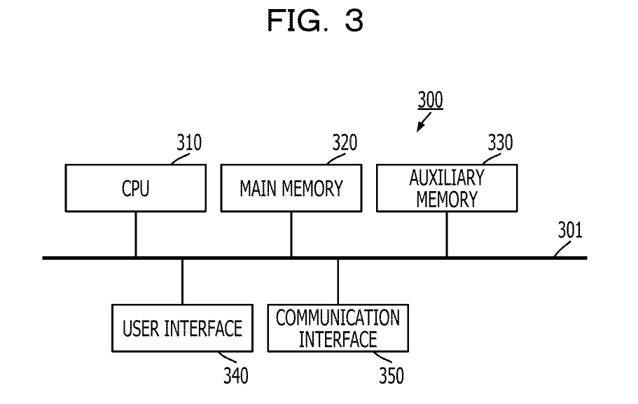

FIG. 3 is a diagram illustrating an example of the hardware configuration of a server. The server 210 illustrated in FIG. 2 can be realized, for example, by an information processing apparatus 300 illustrated in FIG. 3. The information processing apparatus 300 includes a central processing unit (CPU) 310, a main memory 320, an auxiliary memory 330, a user interface 340, and a communication interface 350. The CPU 310, the main memory 320, the auxiliary memory 330, the user interface 340, and the communication interface 350 are connected to one another by a bus 301.

The CPU 310 controls the entirety of the information processing apparatus 300. Alternatively, the information processing apparatus 300 may include a plurality of CPUs 310. The main memory 320 is, for example, a random-access memory (RAM). The main memory 320 is used as a work area of the CPU 310. The auxiliary memory 330 is, for example, a nonvolatile memory such as a hard disk, an optical disk, or a flash memory. The auxiliary memory 330 stores various programs for operating the information processing apparatus 300. The programs stored in the auxiliary memory 330 are loaded into the main memory 320 and executed by the CPU 310.

The user interface 340 includes, for example, an input device that receives an operation by a user and an output device that outputs information to the user. The input device can be realized, for example, by keys (for example, a keyboard), a remote control, or the like. The output device can be realized, for example, by a display, a speaker, or the like. Alternatively, the input device and the output device may be realized by a touch panel or the like. The user interface 340 is controlled by the CPU 310.

The communication interface 350 is, for example, a communication interface that communicates with the base station 230 through the network 220. Communication with the mobile communication terminal 240 through the base station 230 is made possible by the communication interface 350. The communication interface 350 is controlled by the CPU 310.

Hardware Configuration of Mobile Communication Terminal

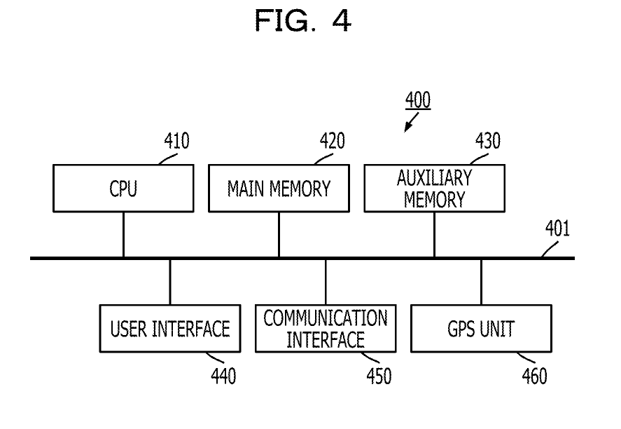

FIG. 4 is a diagram illustrating an example of the hardware configuration of a mobile communication terminal. The mobile communication terminal 240 illustrated in FIG. 2 can be realized, for example, by an information processing apparatus 400 illustrated in FIG. 4. The information processing apparatus 400 includes a CPU 410, a main memory 420, an auxiliary memory 430, a user interface 440, a communication interface 450, and a GPS unit 460. The CPU 410, the main memory 420, the auxiliary memory 430, the user interface 440, the communication interface 450, and the GPS unit 460 are connected to one another by a bus 401.

The CPU 410, the main memory 420, the auxiliary memory 430, the user interface 440, and the communication interface 450 are the same as the CPU 310, the main memory 320, the auxiliary memory 330, the user interface 340, and the communication interface 350, respectively, illustrated in FIG. 3. However, the communication interface 450 is, for example, a communication interface that wirelessly communicates with the base station 230. Communication with the server 210 through the base station 230 is made possible by the communication interface 350.

The GPS unit 460 is an apparatus that receives a GPS signal from the GPS satellite 201 illustrated in FIG. 2 and identifies the current position of the mobile communication terminal 240 based on the received GPS signal. The GPS unit 460 is controlled by the CPU 310.

Functional Configuration of Server According to First Embodiment

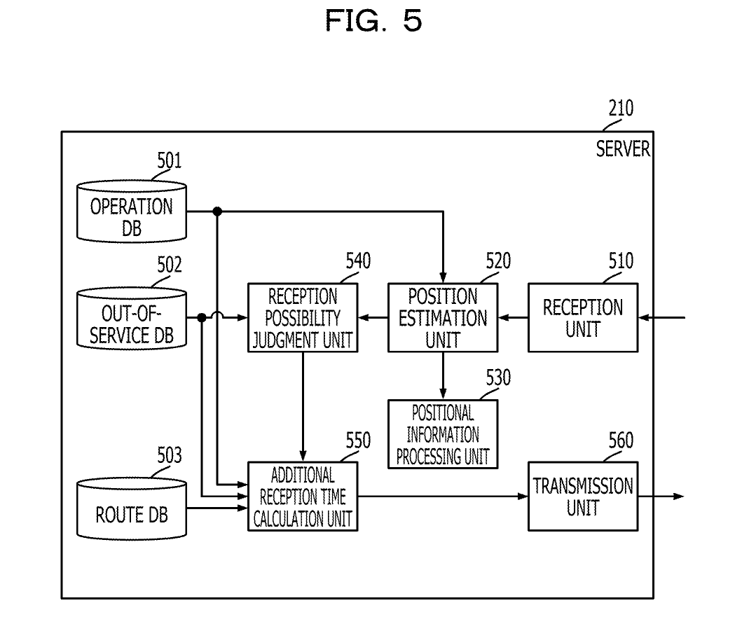

FIG. 5 is a diagram illustrating an example of the functional configuration of a server according to the first embodiment. As illustrated in FIG. 5, the server 210 includes an operation DB 501, an out-of-service DB 502, a route DB 503, a reception unit 510, a position estimation unit 520, a positional information processing unit 530, a reception possibility judgment unit 540, an additional reception time calculation unit 550, and a transmission unit 560.

The operation DB 501, the out-of-service DB 502, and the route DB 503 are, for example, stored in the auxiliary memory 330 illustrated in FIG. 3. Alternatively, the operation DB 501, the out-of-service DB 502, and the route DB 503 may be input from the outside through, for example, the user interface 340 or the communication interface 350 illustrated in FIG. 3 and stored in the main memory 320.

The reception unit 510 and the transmission unit 560 can be realized, for example, by the communication interface 350 illustrated in FIG. 3. The position estimation unit 520, the positional information processing unit 530, the reception possibility judgment unit 540, and the additional reception time calculation unit 550 can be realized, for example, by the CPU 310 illustrated in FIG. 3.

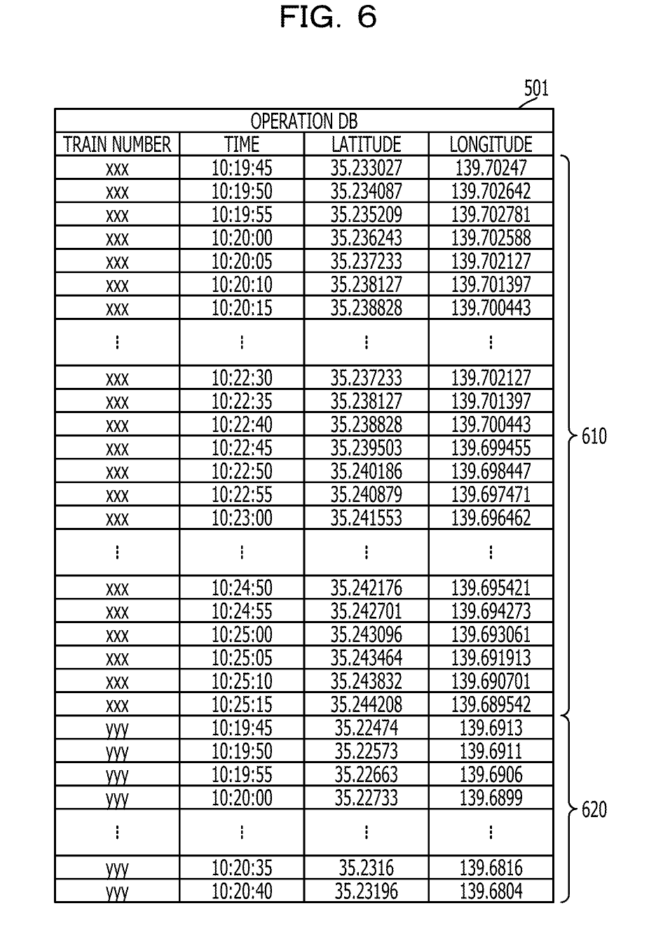

The operation DB 501 is a database that stores information regarding the operation of each train on a railroad or the like (for example, refer to FIG. 6). For example, the operation DB 501 stores information regarding correspondence between times and positions for each train. Each position is, for example, indicated by a combination between a latitude and a longitude. The information regarding correspondence between times and positions can be created, for example, by assuming that a train moves from station to station at a regular speed based on times at which the train arrives at and departs from each station and the position of each station. Alternatively, the information regarding correspondence between times and positions may be created while taking into consideration the acceleration of a train measured before the train arrives at a certain station after the train departs from a previous station.

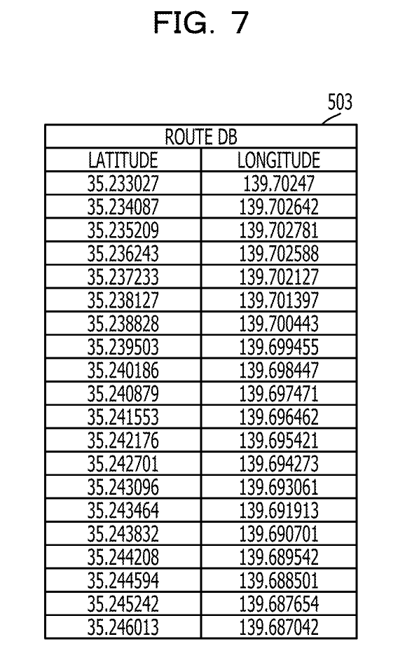

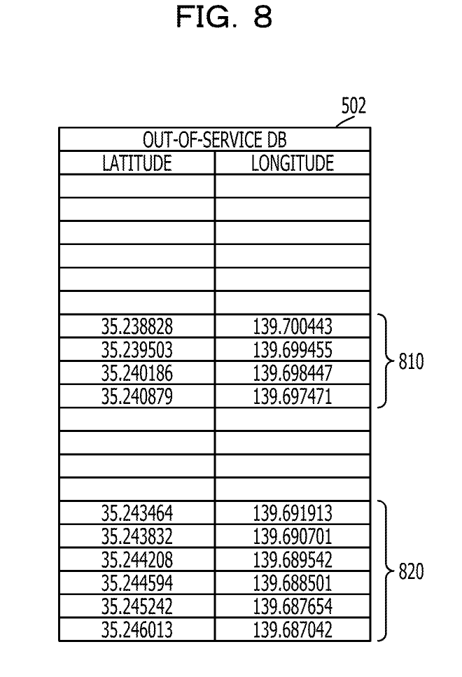

The out-of-service DB 502 is a database that stores, among positions stored in the operation DB 501, positions (or the range of positions) included in dead zones, in which GPS signal are not received (for example, refer to FIG. 8). The route DB 503 is a database that stores the positions stored in the operation DB 501 (for example, refer to FIG. 7). The out-of-service DB 502 and the route DB 503 may be realized by a single database.

The reception unit 510 receives positional information from the mobile communication terminal 240 through the base station 230. The positional information is, for example, a combination between a latitude and a longitude. The reception unit 510 outputs the received positional information to the position estimation unit 520.

The position estimation unit 520 is an estimation unit that estimates the position of the mobile communication terminal 240 at each time. More specifically, the position estimation unit 520 estimates the position of the mobile communication terminal 240 at each time other than the positions indicated by the positional information output from the reception unit 510 on the basis the positions indicated by the positional information from the mobile communication terminal 240. In addition, when positional information has been newly output from the reception unit 510, the position estimation unit 520 corrects results of the estimation of the position of the mobile communication terminal 240 based on the new positional information in order to sequentially estimate the positions of the mobile communication terminal 240.

For example, the position estimation unit 520 estimates the position of the mobile communication terminal 240 based on the positional information output from the reception unit 510 and the operation DB 501. The position estimation unit 520 transmits the result of the estimation of the position of the mobile communication terminal 240 at each time to the positional information processing unit 530.

In addition, the position estimation unit 520 estimates the position of the mobile communication terminal 240 at a next reception time at which the mobile communication terminal 240 receives a GPS signal. More specifically, the position estimation unit 520 identifies a train in which the mobile communication terminal 240 is used based on the positional information output from the reception unit 510 and the operation DB 501.

The position estimation unit 520 can estimate the position of the mobile communication terminal 240 at the next reception time at which the mobile communication terminal 240 receives a GPS signal by obtaining, from the operation DB 501, a position corresponding to a combination between the identified train and the next reception time at which the mobile communication terminal 240 receives a GPS signal. The position estimation unit 520 transmits the estimated position of the mobile communication terminal 240 at the next reception time to the reception possibility judgment unit 540.

The method for estimating the position of the mobile communication terminal 240 is not limited to one in which the operation DB 501 is used, and, for example, a method in which speed information obtained from the positional information and the route DB 503 are used may be adopted.

In addition, the server 210 obtains, from, for example, the mobile communication terminal 240 through the reception unit 510, the periodical reception times at which the mobile communication terminal 240 receives GPS signals. For example, when starting communication with the server 210, the mobile communication terminal 240 transmits the next reception time at which the mobile communication terminal 240 receives a GPS signal and the reception intervals of GPS signals to the server 210. In doing so, the server 210 can calculate the periodical reception times of the mobile communication terminal 240 using an expression “Next reception time+Reception intervals×N (N=1, 2, 3 . . . )”.

In addition, when the periodical reception times at which GPS signals are received have been changed, the mobile communication terminal 240 transmits the next reception time at which the mobile communication terminal 240 receives a GPS signal and the reception intervals of GPS signals to the server 210 again. In doing so, the server 210 can calculate the periodical reception times of the mobile communication terminal 240 after the change.

The positional information processing unit 530 executes processing based on the result of the position estimation output from the position estimation unit 520. For example, when the mobile communication terminal 240 is to download data, the positional information processing unit 530 identifies one of the estimated future positions of the mobile communication terminal 240 at which the communication conditions are sufficient. The identification of a position at which the communication conditions are sufficient can be performed, for example, based on a database indicating the communication conditions of each position.

The positional information processing unit 530 identifies a time at which the mobile communication terminal 240 reaches the identified position based on the operation DB 501 and transmits a signal for instructing the mobile communication terminal 240 to download data at the identified time to the mobile communication terminal 240 through the transmission unit 560. In doing so, the mobile communication terminal 240 can be controlled in such a way as to download the data at a position at which the communication conditions are sufficient. However, the processing executed by the positional information processing unit 530 based on the result of the position estimation is not limited to the control of the timing of the downloading of data, and various types of processing such as transmitting information relating to the identified position to the mobile communication terminal 240 through the transmission unit 560 may be adopted.

The reception possibility judgment unit 540 judges whether or not the mobile communication terminal 240 can actually receive a GPS signal at a next reception time at which the mobile communication terminal 240 receives the GPS signal. More specifically, the reception possibility judgment unit 540 judges whether or not the position of the mobile communication terminal 240 at the next reception time transmitted from the position estimation unit 520 is included in the dead zones stored in the out-of-service DB 502. The reception possibility judgment unit 540 transmits a result of the judgment to the additional reception time calculation unit 550.

Upon receiving, from the reception possibility judgment unit 540, the result of the judgment that the mobile communication terminal 240 does not actually receive a GPS signal at the next reception time at which the mobile communication terminal 240 receives the GPS signal, the additional reception time calculation unit 550 calculates an additional reception time at which the mobile communication terminal 240 receives a GPS signal. More specifically, as illustrated in FIG. 1B, the additional reception time calculation unit 550 calculates a time that comes before the mobile communication terminal 240 enters a dead zone as the additional reception time.

For example, the additional reception time calculation unit 550 obtains a position at which the mobile communication terminal 240 enters a dead zone from the operation DB 501 and the out-of-service DB 502, and identifies a position immediately before the obtained position from the route DB 503. In consideration of accuracy, the additional reception time calculation unit 550 may identify a position located a certain distance (for example, 50 m) before the obtained position.

The additional reception time calculation unit 550 then identifies a time at which the train reaches the identified position from the operation DB 501. Thus, it is possible to calculate the time immediately before the mobile communication terminal 240 enters a dead zone. The additional reception time calculation unit 550 transmits a reception control signal that includes the calculated time as the additional reception time to the transmission unit 560.

Alternatively, the additional reception time calculation unit 550 may calculate a time that comes a first certain period of time before the time at which the train reaches the identified position. The first certain period of time is, for example, the time taken for the mobile communication terminal 240 to complete the operation for receiving a GPS signal after beginning the operation. Thus, it is possible to avoid a situation in which, even though the mobile communication terminal 240 has executed the operation for receiving a GPS signal at the additional reception time, the GPS signal is not received because the mobile communication terminal 240 has entered a dead zone before the reception of the GPS signal is completed.

Alternatively, the time taken for the mobile communication terminal 240 to transmit positional information based on a received GPS signal to the server 210 may be added to the first certain period of time. In doing so, it is possible to avoid a situation in which, even though the mobile communication terminal 240 has received the GPS signal at the additional reception time, the positional information is not transmitted because the mobile communication terminal 240 has entered a dead zone before the transmission of the positional information to the server 210 is completed.

Alternatively, the additional reception time calculation unit 550 may calculate a time that comes before the train reaches the identified position and that comes a second certain period of time after one of the periodical reception times immediately before the train reaches the identified position. In doing so, a difference between the calculated additional reception time and the one of the periodical reception times can be made longer than the second certain period of time. Therefore, it is possible to avoid a situation in which a GPS signal is received at the additional reception time under a condition in which the effect of improving the accuracy of position estimation is small even if the GPS signal is received at the additional reception time because a period between the additional reception time and the one of the periodical reception times is short. Therefore, the power consumption of the mobile communication terminal 240 can be suppressed.

Alternatively, if the difference between the calculated additional reception time and the one of the periodical reception times is smaller than or equal to the second certain period of time, the additional reception time calculation unit 550 does not output the calculated additional reception time to the transmission unit 560. In doing so, in a situation in which the effect of improving the accuracy of position estimation is small even if a GPS signal is received at the additional reception time, a reception control signal is not transmitted to the mobile communication terminal 240 and therefore the mobile communication terminal 240 does not receive the GPS signal at the additional reception time. Therefore, the power consumption of the mobile communication terminal 240 can be suppressed.

Alternatively, as illustrated in FIG. 1C, the additional reception time calculation unit 550 may calculate a time that comes after the mobile communication terminal 240 exits from a dead zone as the additional reception time. More specifically, the additional reception time calculation unit 550 obtains the position at which the mobile communication terminal 240 exits from the dead zone from the operation DB 501 and the out-of-service DB 502 and identifies a position immediately after the obtained position from the route DB 503. In consideration of accuracy, the additional reception time calculation unit 550 may identify a position located a certain distance (for example, 50 m) after the obtained position.

The additional reception time calculation unit 550 then identifies the time at which the train reaches the identified position from the operation DB 501. In doing so, the mobile communication terminal 240 can calculate the time immediately after the mobile communication terminal 240 exits from the dead zone. The additional reception time calculation unit 550 outputs a reception control signal that includes the calculated time as the additional reception time to the transmission unit 560.

Alternatively, the additional reception time calculation unit 550 may calculate a time that comes a third certain period of time after the time at which the train reaches the identified position. In doing so, a difference between the calculated additional reception time and the one of the periodical reception times can be made longer than the third certain period of time. Therefore, it is possible to avoid a situation in which a GPS signal is received at the additional reception time under a condition in which the effect of improving the accuracy of position estimation is small even if the GPS signal is received at the additional reception time because a period between the additional reception time and the one of the periodical reception times is short. Therefore, the power consumption of the mobile communication terminal 240 can be suppressed.

Alternatively, if the difference between the calculated additional reception time and the one of the periodical reception times is smaller than or equal to the third certain period of time, the additional reception time calculation unit 550 does not output the calculated additional reception time to the transmission unit 560. In doing so, in a situation in which the effect of improving the accuracy of position estimation is small even if a GPS signal is received at the additional reception time, a reception control signal is not transmitted to the mobile communication terminal 240 and therefore the mobile communication terminal 240 does not receive the GPS signal at the additional reception time. Therefore, the power consumption of the mobile communication terminal 240 can be suppressed.

Alternatively, as illustrated in FIG. 1D, the additional reception time calculation unit 550 may calculate a time that comes before the mobile communication terminal 240 enters a dead zone and a time that comes after the mobile communication terminal 240 exits from the dead zone as additional reception times. In this case, the additional reception time calculation unit 550 outputs a reception control signal including the calculated additional reception times to the transmission unit 560.

The transmission unit 560 is a control unit that controls the mobile communication terminal 240 such that the mobile communication terminal 240 receives a GPS signal at an additional reception time calculated by the additional reception time calculation unit 550. More specifically, the transmission unit 560 transmits a reception control signal output from the additional reception time calculation unit 550 to the mobile communication terminal 240 through the base station 230. In doing so, the mobile communication terminal 240 can receive the GPS signal before the mobile communication terminal 240 enters a dead zone.

Databases of Server

FIG. 6 is a diagram illustrating an example of an operation DB. As illustrated in FIG. 6, the operation DB 501 includes items of train number, time, latitude, and longitude. Train numbers “xxx” and “yyy” are information for identifying trains. In the operation DB 501, operation information 601 including times, latitudes, and longitudes regarding a train whose train number is “xxx” and operation information 620 including times, latitudes, and longitudes regarding a train whose train number is “yyy”.

For example, a first record in the operation DB 501 indicates that the train having the train number “xxx” is to be located at a position defined by latitude “35.233027” and longitude “139.70247” at time “10:19:45”. Thus, the operation DB 501 is information including positions identified by GPS signals received by the mobile communication terminal 240 and information regarding correspondence between times and future positions of trains (movable bodies) operated along a certain route.

FIG. 7 is a diagram illustrating an example of a route DB. As illustrated in FIG. 7, the route DB 503 is information obtained by extracting the latitudes and the longitudes included in the operation information 610 or the operation information 620 illustrated in FIG. 6. The positions of targets of the operation DB 501 along the route can be obtained by the route DB 503.

FIG. 8 is a diagram illustrating an example of an out-of-service DB. As illustrated in FIG. 8, the out-of-service DB 502 is information obtained by extracting positions included in dead zones (out-of-service zones) from the positions indicated by the route DB 503 illustrated in FIG. 7. In the out-of-service DB 502 illustrated in FIG. 8, pieces of dead zone information 810 and 820 indicating two dead zones are included.

The dead zone information 810 indicates a dead zone extending from a position defined by latitude “35.238828” and longitude “139.700443” to a position defined by latitude “35.240879” and longitude “139.697471”. The dead zone information 820 indicates a dead zone extending from a position defined by latitude “35.243464” and longitude “139.691913” to a position defined by latitude “35.246013” and longitude “139.687042”.

Functional Configuration of Mobile Communication Terminal According to First Embodiment

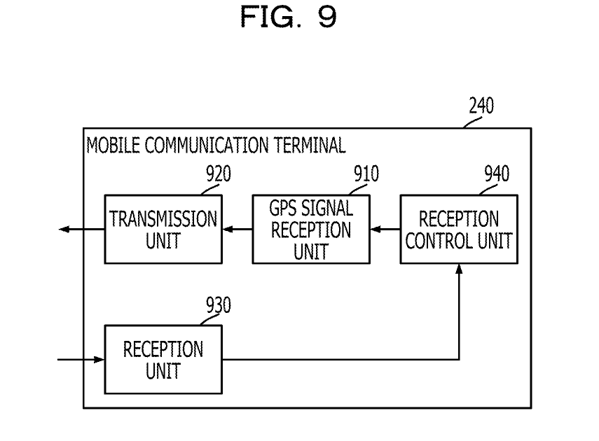

FIG. 9 is a diagram illustrating an example of the functional configuration of a mobile communication terminal according to the first embodiment. As illustrated in FIG. 9, the mobile communication terminal 240 includes a GPS signal reception unit 910, a transmission unit 920, a reception unit 930, and a reception control unit 940.

The GPS signal reception unit 910 can be realized, for example, by the GPS unit 460 illustrated in FIG. 4. The transmission unit 920 and the reception unit 930 can be realized, for example, by the communication interface 450 illustrated in FIG. 4. The reception control unit 940 can be realized, for example, by the CPU 410 illustrated in FIG. 4.

The GPS signal reception unit 910 receives a GPS signal from the GPS satellite 201. The timing at which the GPS signal reception unit 910 executes an operation for receiving a GPS signal is controlled by the reception control unit 940. The GPS signal reception unit 910 outputs positional information indicating a position identified by the received GPS signal to the transmission unit 920. However, the positional information output from the GPS signal reception unit 910 is not limited to the information indicating the position identified by the received GPS signal, and may be the received GPS signal itself or the like, instead, insofar as the information can be used to identify the current position of the mobile communication terminal 240.

The transmission unit 920 transmits the positional information output from the GPS signal reception unit 910 to the server 210 through the base station 230. The reception unit 930 receives a reception control signal transmitted from the server 210 through the base station 230. The reception unit 930 outputs the received reception control signal to the reception control unit 940.

The reception control unit 940 controls the GPS signal reception unit 910 such that the GPS signal reception unit 910 executes the operation for receiving a GPS signal at periodical reception times. In addition, when the reception unit 930 has output a reception control signal, the reception control unit 940 controls the GPS signal reception unit 910 such that the GPS signal reception unit 910 executes the operation for receiving a GPS signal also at an additional reception time included in the reception control signal.

Operation of Server According to First Embodiment

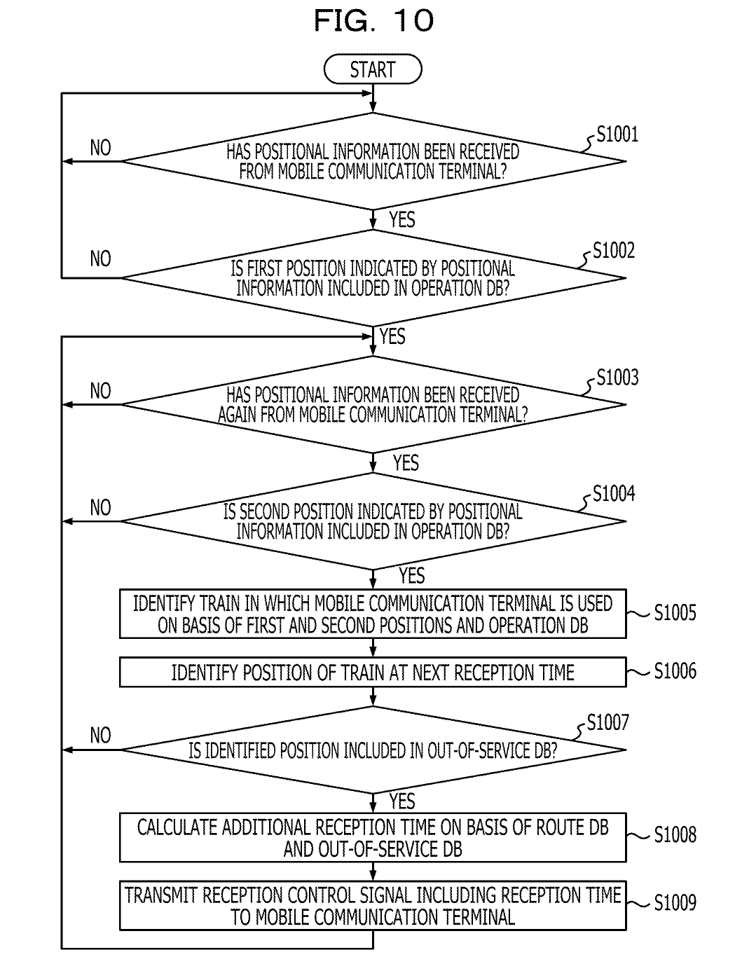

FIG. 10 is a flowchart illustrating an example of the operation of a server according to the first embodiment. For example, the server 210 executes the following steps. First, the server 210 judges whether or not positional information has been received from the mobile communication terminal 240 (step S1001), and waits until positional information is received (loop in the case of NO in step S1001).

If positional information has been received in step S1001 (YES in step S1001), the server 210 judges whether or not a first position indicated by the received positional information is included in the operation DB 501 (step S1002). If the first position is not included in the operation DB 501 (NO in step S1002), it can be judged that the mobile communication terminal 240 is not used in a train operated in accordance with operation DB 501. In this case, the server 210 returns to step S1001.

If the first position is included in the operation DB 501 in step S1002 (YES in step S1002), the server 210 judges whether or not positional information has been received again from the mobile communication terminal 240 (step S1003), and waits until positional information is received (loop in the case of NO in step S1003).

If positional information has been received again in step S1003 (YES in step S1003), the server 210 judges whether or not a second position indicated by the positional information received again is included in the operation DB 501 (step S1004). If the second position is not included in the operation DB 501 (NO in step S1004), the server 210 returns to step S1003.

If the second position is included in the operation DB 501 in step S1004 (YES in step S1002), the server 210 identifies a train in which the mobile communication terminal 240 is used based on the first and second positions indicated by the pieces of positional information received in steps S1001 and S1003, respectively, and the operation DB 501 (step S1005).

Next, the server 210 identifies the position of the train identified in step S1005 at a next periodical reception time of the mobile communication terminal 240 based on the operation DB 501 (step S1006). In doing so, it is possible to identify the position of the mobile communication terminal 240 at the next periodical reception time of the mobile communication terminal 240.

Next, the server 210 judges whether or not the position identified in step S1006 is included in the out-of-service DB 502 (step S1007). If the identified position is not included in the out-of-service DB 502 (NO in step S1007), the server 210 returns to step S1003.

If the identified position is included in the out-of-service DB 502 in step S1007 (YES in step S1007), it can be judged that the mobile communication terminal 240 is located in a dead zone at the next periodical reception time of the mobile communication terminal 240. In this case, the server 210 calculates an additional reception time based on the route DB 503 and the out-of-service DB 502 (step S1008).

Next, the server 210 transmits a reception control signal including the additional reception time calculated in step S1008 to the mobile communication terminal 240 (step S1009), and returns to step S1003. By executing the above steps, the server 210 can cause the mobile communication terminal 240 to receive a GPS signal before the mobile communication terminal 240 enters a dead zone when the mobile communication terminal 240 has been estimated to be located in the dead zone at the next periodical reception time of the mobile communication terminal 240.

In steps S1002 and S1004, if a position whose distance to the position indicated by the positional information is smaller or equal to a certain value is included in the operation DB 501, it may be judged that the position indicated by the positional information is included in the operation DB 501.

Operation of Mobile Communication Terminal According to First Embodiment

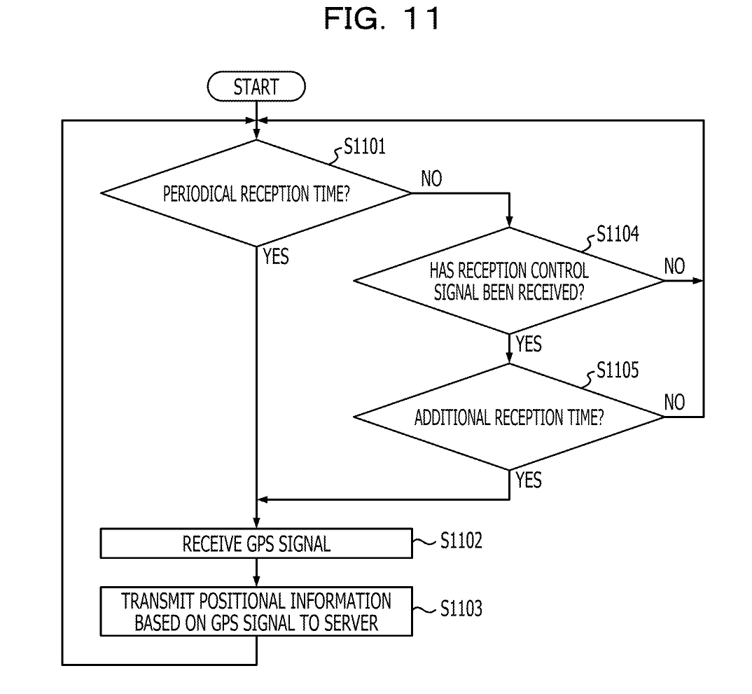

FIG. 11 is a flowchart illustrating an example of the operation of a mobile communication terminal according to the first embodiment. For example, the mobile communication terminal 240 executes the following steps. First, the mobile communication terminal 240 judges whether or not a periodical reception time has come (step S1101). If a periodical reception time has come (YES in step S1101), the mobile communication terminal 240 receives a GPS signal from the GPS satellite 201 (step S1102).

Next, the mobile communication terminal 240 transmits positional information based on the GPS signal received in step S1102 to the server 210 (step S1103), and returns to step S1101. If a periodical reception time has not yet come (NO in step S1101), the mobile communication terminal 240 judges whether or not a reception control signal has been received from the server 210 (step S1104).

If a reception control signal has not yet been received in step S1104 (NO in step S1104), the mobile communication terminal 240 returns to step S1101. If a reception control signal has been received (YES in step S1104), the mobile communication terminal 240 judges whether or not an additional reception time included in the received reception control signal has come (step S1105). If an additional reception time has not yet come (NO in step S1105), the mobile communication terminal 240 returns to step S1101.

If an additional reception time has come in step S1105 (YES in step S1105), the mobile communication terminal 240 proceeds to step S1102. In doing so, the mobile communication terminal 240 can receive a GPS signal at the periodical reception time and transmit the GPS signal to the server 210, and, when the mobile communication terminal 240 has received a reception control signal from the server 210, the mobile communication terminal 240 can receive a GPS signal also at the additional reception time and transmit positional information to the server 210.

Specific Example of Operation of Communication System

Suppose that, for example, the mobile communication terminal 240 has obtained latitude “35.233027” and longitude “139.70247” at 10:19:45 as first positional information and transmitted the obtained positional information to the server 210. The server 210 judges whether or not the positional information transmitted from the mobile communication terminal 240 is included in the operation DB 501.

Since a combination between 10:19:45, latitude “35.233027”, and longitude “139.70247” is included in the operation DB 501 illustrated in FIG. 6, it can be judged that the mobile communication terminal 240 is used in a train operating along a route corresponding to the operation DB 501. However, since the above combination is included in both the train number “xxx” and the train number “yyy”, which train the mobile communication terminal 240 is used in is not clear at this point of time.

Suppose that the mobile communication terminal 240 has obtained latitude “35.237233” and longitude “139.702127” at 10:22:30 as second positional information and transmitted the obtained positional information to the server 210. The server 210 judges whether or not the positional information transmitted from the mobile communication terminal 240 is included in the operation DB 501.

A combination between 10:22:30, latitude “35.237233”, and longitude “139.702127” is included in the operation DB 501 illustrated in FIG. 6. Therefore, the server 210 can judge that the mobile communication terminal 240 is used in a train having the train number “xxx” based on a combination between the first positional information and the second positional information.

Next, the server 210 calculates a next periodical reception time of the mobile communication terminal 240. For example, if the previous periodical reception time is 10:20:05 and the intervals of periodical reception are 5 minutes, the next periodical reception time is 10:25:05. The server 210 identifies the position of the mobile communication terminal 240 at the next reception time, namely 10:25:05, from the operation DB 501. For example, the server 210 obtains the position of the train having the train number “xxx” at 10:25:05 using the operation DB 501 illustrated in FIG. 6. In doing so, it is possible to identify the position of the mobile communication terminal 240 at the next reception time is a position defined by latitude “35.243464” and longitude “139.691913”.

Thus, the server 210 identifies the train (train number “xxx”) in which the mobile communication terminal 240 is used based on the operation DB 501 and obtains correspondence information (the operation information 610) corresponding to the identified train from the operation DB 501. The server 210 can estimate the position of the mobile communication terminal 101 at each time based on the obtained correspondence information.

Since the identified latitude “35.243464” and longitude “139.691913” are included in the out-of-service DB 502, the server 210 can estimate that the mobile communication terminal 240 is to be located in a dead zone at the next periodical reception time. Therefore, the server 210 calculates a position of the train having the train number “xxx” immediately before the dead zone including latitude “35.243464” and longitude “139.691913” from the operation DB 501.

For example, since a position defined by latitude “35.243464” and longitude “139.691913” is located at the beginning of a dead zone, the server 210 obtains, from the route DB 503, a previous position of a position immediately before (alternatively, a previous position of) the position defined by latitude “35.243464” and longitude “139.691913”. In this case, latitude “35.242701” and longitude “139.694273” are obtained from the route DB 503 illustrated in FIG. 7.

The server 210 identifies a time at which the train having the train number “xxx” reaches the obtained position from the operation DB 501. In the example of the operation DB 501 illustrated in FIG. 6, “10:24:55” is identified. The server 210 transmits a reception control signal that includes the identified “10:24:55” as an additional reception time to the mobile communication terminal 240. In doing so, the mobile communication terminal 240 can receive a GPS signal immediately before the mobile communication terminal 240 enters the dead zone.

As described above, according to the first embodiment, it is possible to add a reception time to a mobile communication terminal that receives GPS signals at periodical reception times such that the mobile communication terminal receives a GPS signal immediately before or after a dead zone. Therefore, a period for which a GPS signal is not received while the mobile communication terminal passes through the dead zone can be shortened, thereby improving the accuracy of the estimation of the position of the mobile communication terminal.

By causing the mobile communication terminal to receive GPS signals not only at the periodical reception times but also at a reception time before the calculated dead zone, it is possible to cause the mobile communication terminal to receive a GPS signal at a reception time before the calculated dead zone by simple control. However, the method for causing the mobile communication terminal to receive a GPS signal at a reception time before the calculated dead zone is not limited to this. For example, by changing all the periodical reception times at which the mobile communication terminal receives GPS signals by the same period of time, it is possible to cause the mobile communication terminal to receive a GPS signal at a reception time before the calculated dead zone. Alternatively, by changing the intervals of periodical reception at which the mobile communication terminal receives GPS signals, it is possible to cause the mobile communication terminal to receive a GPS signal at a reception time before the calculated dead zone.

### Second Embodiment

With respect to a second embodiment, differences from the first embodiment will be described. A terminal control apparatus according to the second embodiment causes, for example, the mobile communication terminal 101 to receive a GPS signal at an additional reception time and then controls the mobile communication terminal 101 such that the operation for receiving GPS signals at periodical reception times stops. In doing so, for example, the power consumption of the mobile communication terminal 101 can be suppressed.

Operation of Server According to Second Embodiment

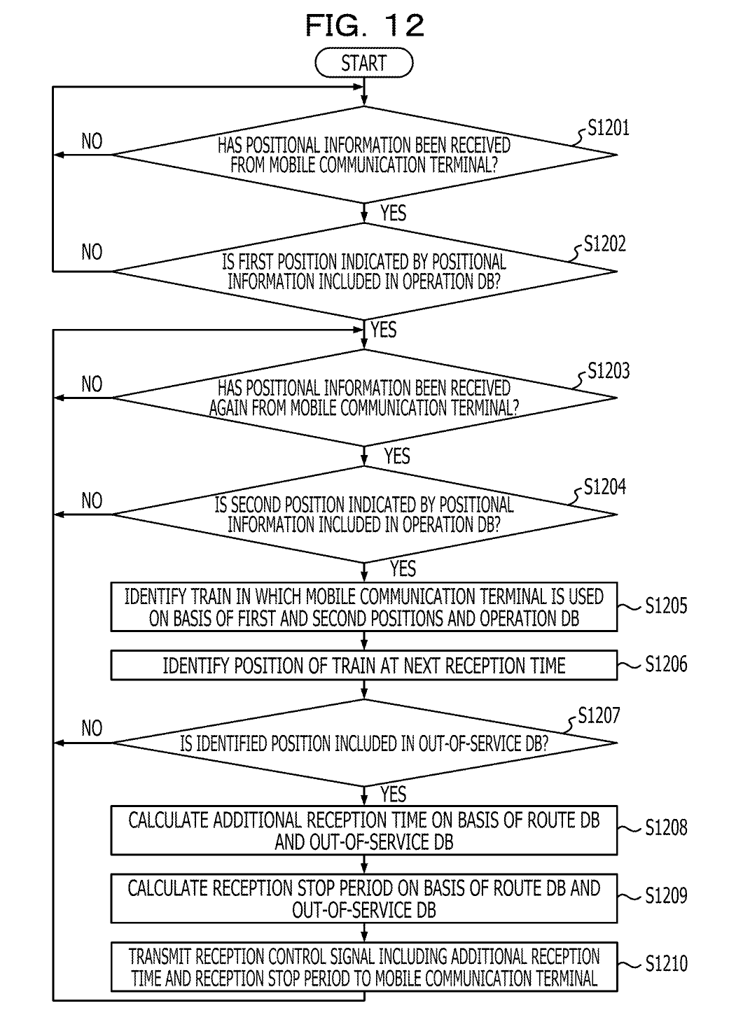

FIG. 12 is a flowchart illustrating an example of the operation of a server according to the second embodiment. For example, a server 210 according to the second embodiment executes the following steps. Steps S1201 to S1208 illustrated in FIG. 12 are the same as steps S1001 to S1008, respectively, illustrated in FIG. 10.

After step S1208, the server 210 calculates a reception stop period based on the route DB 503 and the out-of-service DB 502 (step S1209). The calculation of the reception stop period will be described later. Next, the server 210 transmits a reception control signal including an additional reception time calculated in step S1208 and the reception stop period calculated in step S1209 to the mobile communication terminal 240 (step S1210), and returns to step S1203.

The reception control signal transmitted in step S1210 is a signal for instructing the mobile communication terminal 240 to receive a GPS signal at the additional reception time and, during the reception stop period, to stop the operation for receiving a GPS signal. Therefore, it is possible to cause the mobile communication terminal 240 to receive a GPS signal at the additional reception time and then to control the mobile communication terminal 240 such that the reception of GPS signals at the periodical reception times stops.

In addition, after the mobile communication terminal 240 is caused to stop the operation for receiving a GPS signal, it is possible to control the mobile communication terminal 240 such that the mobile communication terminal 240 resumes the operation for receiving a GPS signal before one of the periodical reception times immediately after the mobile communication terminal 240 exits from a dead zone. In doing so, it is possible to avoid a situation in which, although the mobile communication terminal 240 has exited from the dead zone, a GPS signal is not received at a periodical reception time, thereby suppressing a decrease in the accuracy of the estimation of the position of the mobile communication terminal 240 while suppressing the power consumption of the mobile communication terminal 240.

In step S1209, for example, the additional reception time calculation unit 550 of the server 210 obtains a time at which the mobile communication terminal 240 exits from the dead zone from the operation DB 501 and the out-of-service DB 502. The additional reception time calculation unit 550 then calculates, as a time at which the stop ends, an arbitrary time that comes after the obtained time and that comes before one of the periodical reception times immediately after the obtained time. The additional reception time calculation unit 550 then stores, in a reception control signal, a period between the calculated additional reception time and the calculated time at which the stop ends as the reception stop period.

Mobile Communication Terminal According to Second Embodiment

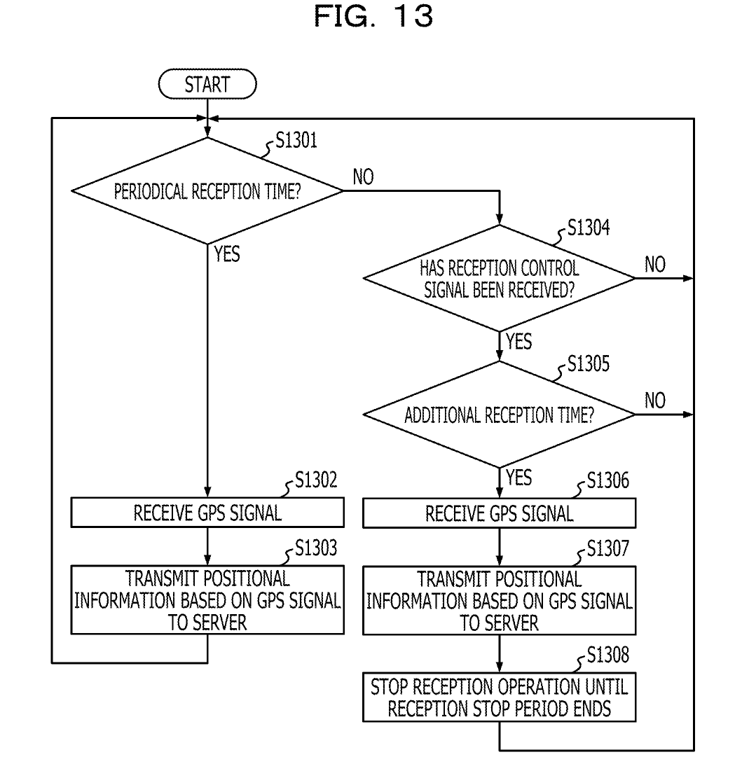

FIG. 13 is a flowchart illustrating an example of a mobile communication terminal according to the second embodiment. For example, the mobile communication terminal 240 according to the second embodiment executes the following steps. Steps S1301 to S1305 illustrated in FIG. 13 are the same as steps S1101 to S1105, respectively, illustrated in FIG. 11.

If an additional reception time has come in step S1305 (YES in step S1305), the mobile communication terminal 240 receives a GPS signal from the GPS satellite 201 (step S1306). Next, the mobile communication terminal 240 transmits positional information received in step S1306 to the server 210 (step S1307).

Next, the mobile communication terminal 240 stops the operation for receiving a GPS signal until a reception stop period included in the received reception control signal ends (step S1308), and returns to step S1301. Therefore, if the mobile communication terminal 240 receives the reception control signal from the server 210, the mobile communication terminal 240 receives a GPS signal also at an additional reception time and transmits the GPS signal to the server 210, and then the mobile communication terminal 240 can stop the operation for receiving a GPS signal until the mobile communication terminal 240 exits from a dead zone. Therefore, the power consumption of the mobile communication terminal 240 can be suppressed.

As described above, according to the second embodiment, after a mobile communication terminal is caused to receive a GPS signal at an additional reception time, it is possible to stop the operation for receiving GPS signals at periodical reception times. Therefore, the power consumption of the mobile communication terminal 101 can be suppressed.

In addition, after the mobile communication terminal is caused to stop the operation for receiving a GPS signal, it is possible to cause the mobile communication terminal to resume the operation for receiving a GPS signal before one of the periodical reception times immediately after the mobile communication terminal exits from a dead zone. Therefore, it is possible to suppress a decrease in the accuracy of the estimation of the position of the mobile communication terminal 240 while suppressing the power consumption of the mobile communication terminal 240.

### Third Embodiment

With respect to a third embodiment, differences from the first embodiment will be described. In the third embodiment, the mobile communication terminal 240 controls times at which the GPS signal reception unit 910 thereof receives GPS signals. In this case, the server 210 does not necessarily have the function of controlling the times at which the mobile communication terminal 240 receives GPS signals.

Alternatively, the mobile communication terminal 240 itself may estimate the position thereof at each time and execute processing based on a result of the estimation. In this case, the mobile communication terminal 240 does not necessarily transmit positional information to the server 210.

Functional Configuration of Mobile Communication Terminal According to Third Embodiment

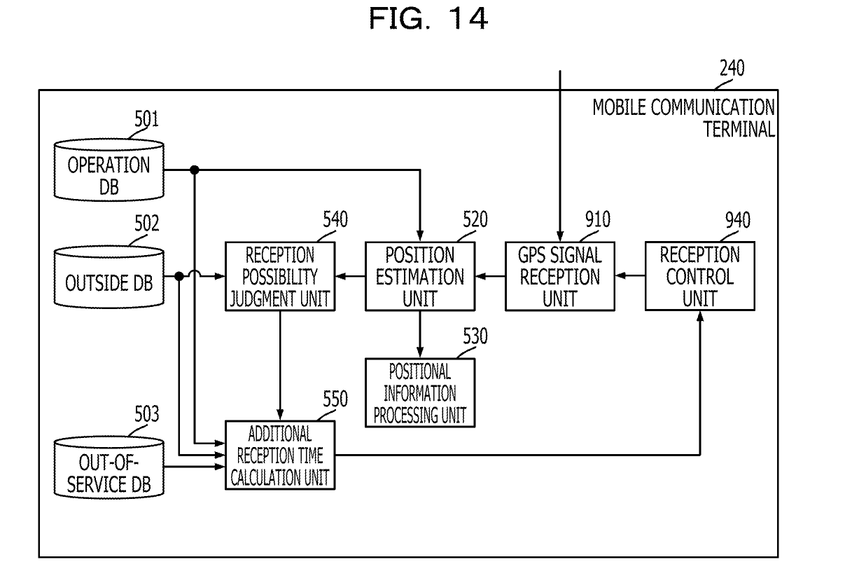

FIG. 14 is a diagram illustrating an example of the functional configuration of a mobile communication terminal according to the third embodiment. In FIG. 14, the same components as those illustrated in FIG. 5 or 9 are given the same reference numerals, and description thereof is omitted. As illustrated in FIG. 14, the mobile communication terminal 240 according to the third embodiment includes an operation DB 501, an out-of-service DB 502, a route DB 503, a position estimation unit 520, a positional information processing unit 530, a reception possibility judgment unit 540, an additional reception time calculation unit 550, a GPS signal reception unit 910, and a reception control unit 940.

The GPS signal reception unit 910 outputs positional information based on a received GPS signal to the position estimation unit 520. The position estimation unit 520 estimates the position of the mobile communication terminal 240 based on the positional information output from the GPS signal reception unit 910.

The additional reception time calculation unit 550 outputs a reception control signal including a calculated time to the reception control unit 940. When the reception control signal has been output from the additional reception time calculation unit 550, the reception control unit 940 controls the GPS signal reception unit 910 such that the operation for receiving a GPS signal is performed also at a time specified by the reception control signal.

Operation for Estimating Position of Mobile Communication Terminal According to Third Embodiment

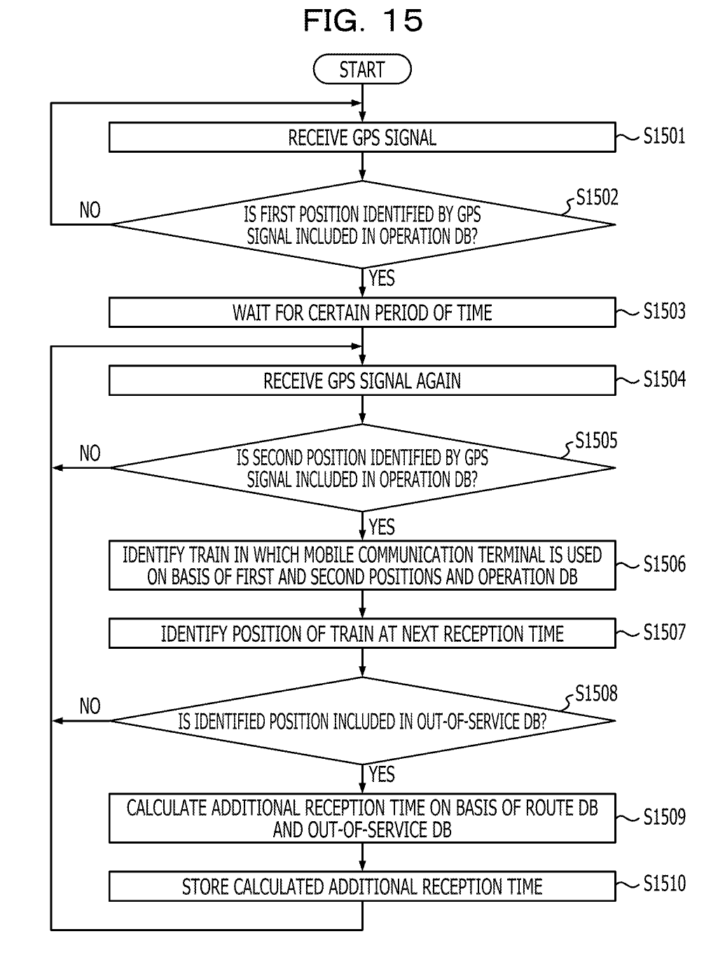

FIG. 15 is a flowchart illustrating an example of the operation for estimating a position executed by the mobile communication terminal according to the third embodiment. For example, the mobile communication terminal 240 according to the third embodiment executes the following steps. First, the mobile communication terminal 240 receives a GPS signal (step S1501). Next, the mobile communication terminal 240 judges whether or not a first position identified by the GPS signal received in step S1504 is included in the operation DB 501 (step S1502). If the first position is not included in the operation DB 501 (NO in step S1502), the mobile communication terminal 240 returns to step S1501.

In step S1502, if the first position is included in the operation DB 501 (YES in step S1502), the mobile communication terminal 240 waits for a certain period of time (step S1503), and then receives a GPS signal again (step S1504).

Next, the mobile communication terminal 240 judges whether or not a second position identified by the GPS signal received again in step S1504 is included in the operation DB 501 (step S1505). If the second position is not included in the operation DB 501 (NO in step S1505), the mobile communication terminal 240 returns to step S1504.

If the second position is included in the operation DB 501 in step S1505 (YES in step S1505), the mobile communication terminal 240 proceeds to step S1506. That is, the mobile communication terminal 240 identifies a train in which the mobile communication terminal 240 is used based on the first and second positions identified by the GPS signals received in step S1501 and S1504, respectively, and the operation DB 501 (step S1506).

Next, the mobile communication terminal 240 identifies the position of the train identified in step S1506 at a next periodical reception time of the mobile communication terminal 240 based on the operation DB 501 (step S1507). Thus, the position of the mobile communication terminal 240 at the next periodical reception time of the mobile communication terminal 240 can be identified.

Next, the mobile communication terminal 240 judges whether or not the position identified in step S1507 is included in the out-of-service DB 502 (step S1508). If the identified position is not included in the out-of-service DB 502 (NO in step S1508), the mobile communication terminal 240 returns to step S1504. If the identified position is included in the out-of-service DB 502 (YES in step S1508), the mobile communication terminal 240 calculates an additional reception time based on the route DB 503 and the out-of-service DB 502 (step S1509).

Next, the mobile communication terminal 240 stores the additional reception time calculated in step S1509 (step S1510), and returns to step S1504. In step S1510, the mobile communication terminal 240 stores a reception control signal in, for example, the main memory 420 or the auxiliary memory 430 illustrated in FIG. 4.

By executing the above steps, the mobile communication terminal 240 can cause the GPS signal reception unit 910 to receive a GPS signal before the mobile communication terminal 240 enters a dead zone when the mobile communication terminal 240 has been estimated to be located in a dead zone at a next periodical reception time thereof.

Operation for Receiving GPS Signal Executed by Mobile Communication Terminal According to Third Embodiment

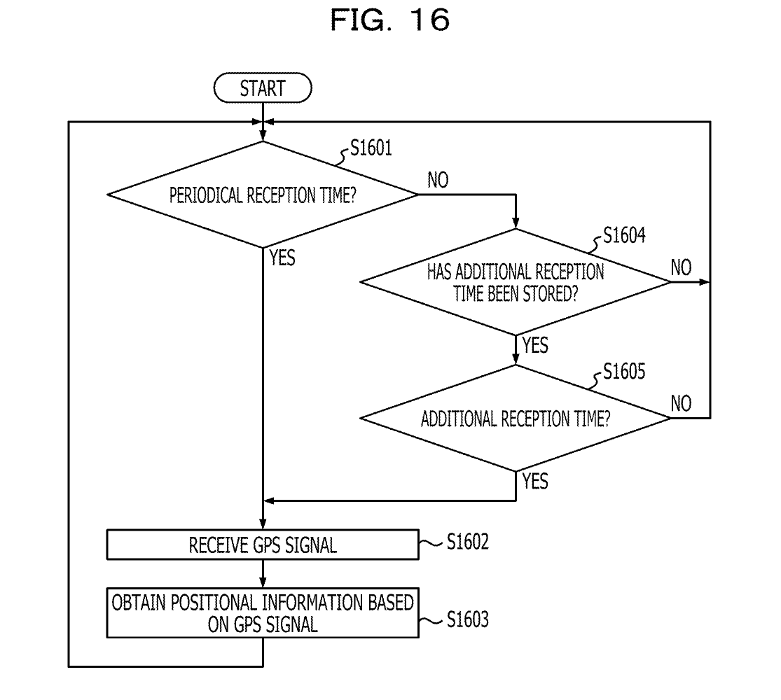

FIG. 16 is a flowchart illustrating an example of an operation for receiving a GPS signal executed by the mobile communication terminal according to the third embodiment. In addition to the steps illustrated in FIG. 15, the mobile communication terminal 240 according to the third embodiment executes the following steps. Steps S1601 and S1602 illustrated in FIG. 16 are the same as steps S1101 and S1102, respectively, illustrated in FIG. 11.

After step S1602, the mobile communication terminal 240 obtains positional information based on a GPS signal received in step S1602 (step S1603). That is, the mobile communication terminal 240 does not necessarily transmit the positional information to the server 210. However, the mobile communication terminal 240 may transmit the positional information to the server 210 in step S1603.

If a periodical reception time has not yet come in step S1601 (NO in step S1601), the mobile communication terminal 240 judges whether or not an additional reception time has been stored in step S1510 illustrated in FIG. 15 (step S1604). If an additional reception time has not been stored (NO in step S1604), the mobile communication terminal 240 returns to step S1601.

If an additional reception time has been stored in step S1604 (YES in step S1604), the mobile communication terminal 240 judges whether or not the stored additional reception time has come (step S1605). If the additional reception time has not yet come (NO in step S1605), the mobile communication terminal 240 returns to step S1601. If the additional reception time has come (YES in step S1605), the mobile communication terminal 240 proceeds to step S1602.

By executing the above steps, the mobile communication terminal 240 can receive a GPS signal at a periodical reception time and obtain positional information, and, when an additional reception time has been stored, the mobile communication terminal 240 can receive a GPS signal also at the additional reception time and obtain positional information.

As described above, according to the third embodiment, by executing the control of the times at which GPS signals are received using a mobile communication terminal, the same effects as those in the first embodiment can be produced without using an external terminal control apparatus (for example, the server 210). Alternatively, in the third embodiment, the operation for receiving a GPS signals at a periodical reception time may stop after a GPS signal is received at an additional reception time as in the second embodiment. Alternatively, in the third embodiment, after the operation for receiving a GPS signal is stopped, the operation for receiving a GPS signal may be resumed before one of the periodical reception times immediately after the mobile communication terminal exits from a dead zone as in the second embodiment.

### Fourth Embodiment

With respect to a fourth embodiment, differences from the first embodiment will be described. In the fourth embodiment, for example, a reception time at which a GPS signal is received is added not only when a mobile communication terminal passes through a dead zone but also when the mobile communication terminal passes through an instable zone, in which the movement of the mobile communication terminal is instable. In doing so, the accuracy of the estimation of the position of the mobile communication terminal can be improved.

Functional Configuration of Server According to Fourth Embodiment

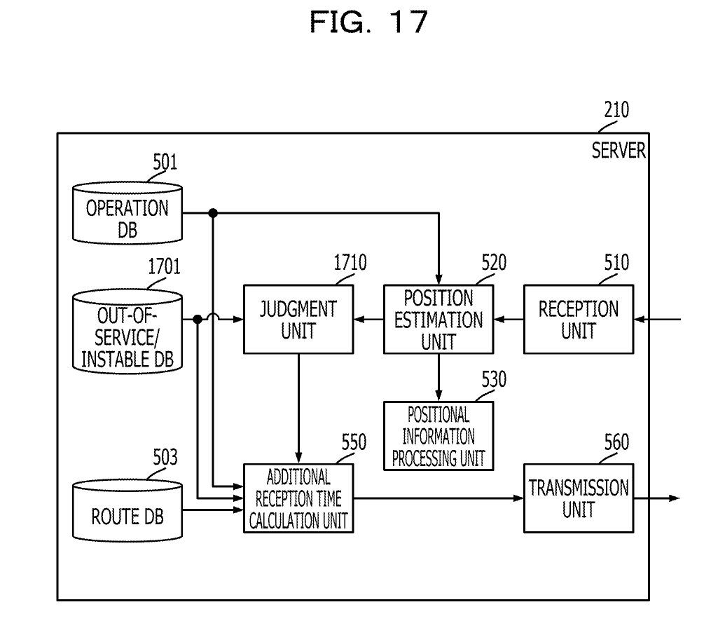

FIG. 17 is a diagram illustrating an example of the functional configuration of a server according to the fourth embodiment. In FIG. 17, the same components as those illustrated in FIG. 5 are given the same reference numerals, and description thereof is omitted. As illustrated in FIG. 17, the server 210 according to the fourth embodiment includes an out-of-service/instable DB 1701 and a judgment unit 1710, instead of the out-of-service DB 502 and the reception possibility judgment unit 540 illustrated in FIG. 5.

For example, the out-of-service/instable DB 1701 is stored in the auxiliary memory 330 illustrated in FIG. 3. Alternatively, the out-of-service/instable DB 1701 may be input from the outside, for example, through the user interface 340 or the communication interface 350 illustrated in FIG. 3 and stored in the main memory 320. The judgment unit 1710 can be realized, for example, by the CPU 310 illustrated in FIG. 3.

The out-of-service/instable DB 1701 is a database that stores, among the positions included in the operation DB 501, positions in instable zones, in which the operation of trains becomes instable, such as stations, in addition to positions included in dead zones, in which GPS signals are not received. Alternatively, the mobile communication terminal 240 may include the route DB 503 illustrated in FIG. 5 and a database that stores positions in instable zones, instead of the out-of-service/instable DB 1701.

The judgment unit 1710 judges whether or not the position of the mobile communication terminal 240 at a next reception time is included in a dead zone based on the out-of-service/instable DB 1701. In addition, the judgment unit 1710 judges whether or not the position of the mobile communication terminal 240 at the next reception time is included in an instable zone based on the out-of-service/instable DB 1701. If the position of the mobile communication terminal 240 at the next reception time is included in at least either a dead zone or an instable zone, the judgment unit 1710 transmits the result to the additional reception time calculation unit 550.

When the additional reception time calculation unit 550 has received, from the judgment unit 1710, the result that the position of the mobile communication terminal 240 at the next reception time is included in at least either a dead zone or an instable zone, the additional reception time calculation unit 550 calculates an additional reception time at which the mobile communication terminal 240 receives a GPS signal. The additional reception time calculation unit 550 calculates the additional reception time by referring to the out-of-service/instable DB 1701, instead of the out-of-service DB 502 illustrated in FIG. 5.

Out-Of-Service/Instable DB

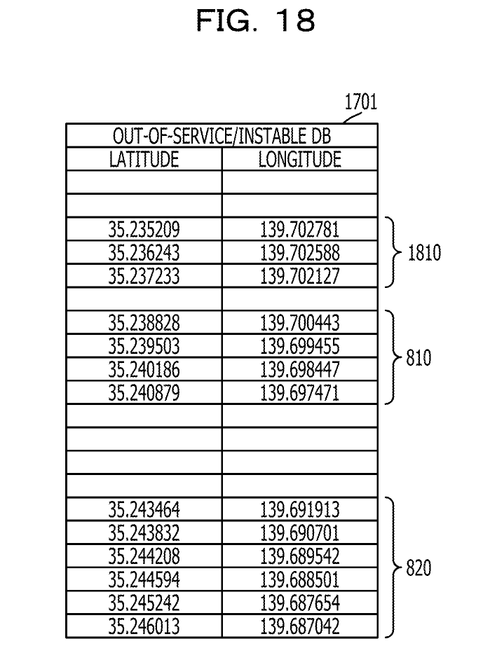

FIG. 18 is a diagram illustrating an example of an out-of-service/instable DB according to the fourth embodiment. In FIG. 18, the same components as those illustrated in FIG. 8 are given the same reference numerals, and description thereof is omitted. As illustrated in FIG. 18, the out-of-service/instable DB 1701 stores instable zone information 1810 in addition to the pieces of dead zone information 810 and 820 illustrated in FIG. 8. The instable zone information 1810 is information indicating positions in instable zones, in which the operation of trains becomes instable, such as stations.

As described above, according to the fourth embodiment, when at least one of positions at periodical reception times is included at least either a dead zone or an instable zone, a reception time can be added such that a GPS signal is received immediately before the dead zone or the instable zone. Thus, by receiving a GPS signal immediately before an instable zone, it is possible to improve the accuracy of the estimation of the position of the mobile communication terminal even in the instable zone, in which position estimation is usually difficult.

As described above, according to the terminal control apparatus, the mobile communication terminal, the method for controlling a terminal, and the communication system, the accuracy of position estimation can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal control apparatus that controls a mobile communication terminal that receives, at periodical reception times, wireless signals for enabling identification of positions of the mobile communication terminal, the terminal control apparatus comprising:
a memory; and
a processor that, when executing a procedure stored in the memory,
estimates a position of the mobile communication terminal at each time including the periodical reception times based on the positions identified by the wireless signals received by the mobile communication terminal,
judges whether or not at least one of the estimated positions at the periodical reception times is included in a dead zone, in which the mobile communication terminal does not receive the wireless signals, based on information indicating the dead zone,
calculates, when judged that at least one of the positions at the periodical reception times is included in the dead zone, based on the estimated position at each time, at least one time that comes before a time at which the mobile communication terminal enters the dead zone and that comes after one of the periodical reception times before the time at which the mobile communication terminal enters the dead zone, and
controls the mobile communication terminal so that the mobile communication terminal receives a wireless signal at the calculated time.

2. The terminal control apparatus according to claim 1,
wherein, after causing the mobile communication terminal to receive the wireless signal at the calculated time, the processor controls the mobile communication terminal so that an operation for receiving the wireless signals at the periodical reception times stops.

3. The terminal control apparatus according to claim 2,
wherein, after causing the mobile communication terminal to stop the operation for receiving the wireless signals, the processor controls the mobile communication terminal so that the operation for receiving the wireless signals resumes before one of the periodical reception times after a time at which the mobile communication terminal exits from the dead zone.

4. The terminal control apparatus according to claim 1,
wherein the processor calculates a time that comes a certain period of time or more before the time at which the mobile communication terminal enters the dead zone.

5. The terminal control apparatus according to claim 1,
wherein the processor calculates a time that comes a certain period of time or more after the one of the periodical reception times before the time at which the mobile communication terminal enters the dead zone.

6. The terminal control apparatus according to claim 1,
wherein, when a difference between the one of the periodical reception times before the time at which the mobile communication terminal enters the dead zone and the time at which the mobile communication terminal enters the dead zone is smaller than or equal to a certain period of time, the processor keeps the mobile communication terminal from receiving the wireless signal at the time calculated by the processor.

7. The terminal control apparatus according to claim 1,
wherein the processor calculates at least one time that comes after the time at which the mobile communication terminal exits from the dead zone and that comes before one of the periodical reception times after the time at which the mobile communication terminal exits from the dead zone, and
wherein the processor controls the mobile communication terminal so that the mobile communication terminal receives a wireless signal at each time calculated by the processor.

8. The terminal control apparatus according to claim 7,
wherein the processor calculates a time that comes a certain period of time or more before the one of the periodical reception times after the time at which the mobile communication terminal exits from the dead zone.

9. The terminal control apparatus according to claim 1,
wherein the processor identifies a movable body in which the mobile communication terminal is used based on the positions identified by the wireless signals received by the mobile communication terminal and operation information including correspondence information regarding correspondence between times and future positions of movable bodies that operate along a certain route, obtains correspondence information corresponding to the identified movable body from the operation information, and estimates the position of the mobile communication terminal at each time based on the obtained correspondence information.

10. The terminal control apparatus according to claim 1,
wherein the processor judges whether or not a position of the mobile communication terminal at one of the periodical reception times after a current time is included in the dead zone.

11. The terminal control apparatus according to claim 1,
wherein the processor judges whether or not at least one of the positions at the periodical reception times is included in at least either the dead zone or an instable zone, in which movement of the mobile communication terminal becomes instable, based on information indicating the dead zone and information indicating the instable zone, and
wherein, when judged that at least one of the positions at the periodical reception times is included in at least either the dead zone or the instable zone, the processor calculates at least one time.

12. A mobile communication terminal comprising:
a receiver that receives wireless signals, at periodical reception times, for enabling identification of positions of the mobile communication terminal; and
a processor that
estimates a position of the mobile communication terminal at each time including the periodical reception times based on the positions identified by the wireless signals received by the receiver,
judges whether or not at least one of the estimated positions at the periodical reception times is included in a dead zone, in which the receiver does not receive the wireless signals, based on information indicating the dead zone, and
calculates, when judged that at least one of the positions at the periodical reception times is included in the dead zone, based on the estimated position at each time, at least one time that comes before a time at which the mobile communication terminal enters the dead zone and that comes after one of the periodical reception times before the time at which the mobile communication terminal enters the dead zone, and
controls the receiver so that the receiver receives a wireless signal at the time calculated by the processor.

13. A method for controlling a terminal by which a mobile communication terminal that receives, at periodical reception times, wireless signals for enabling identification of positions of the mobile communication terminal is controlled, the method comprising:
estimating a position of the mobile communication terminal at each time including the periodical reception times based on the positions identified by the wireless signals received by the mobile communication terminal;
judging whether or not at least one of the estimated positions at the periodical reception times is included in a dead zone, in which the mobile communication terminal does not receive the wireless signals, based on information indicating the dead zone;
calculating, when judged that at least one of the positions at the periodical reception times is included in the dead zone, at least one time that comes after a time at which the mobile communication terminal exits from the dead zone and that comes before one of the periodical reception times after the time at which the mobile communication terminal exits from the dead zone based on the estimated position at each time; and
controlling the mobile communication terminal so that the mobile communication terminal receives a wireless signal at the calculated time.

14. A communication system comprising:
a mobile communication terminal that receives, at periodical reception times, wireless signals for enabling identification of positions of the mobile communication terminal; and
a terminal control apparatus that estimates a position of the mobile communication terminal at each time including the periodical reception times based on the positions identified by the wireless signals received by the mobile communication terminal, that judges whether or not at least one of the estimated positions at the periodical reception times is included in a dead zone, in which the mobile communication terminal does not receive the wireless signals, based on information indicating the dead zone, that, when judged that at least one of the estimated positions at the periodical reception times is included in the dead zone, calculates, based on the estimated position at each time, at least one time that comes after a time at which the mobile communication terminal exits from the dead zone and that comes before one of the periodical reception times after the time at which the mobile communication terminal exits from the dead zone, and that controls the mobile communication terminal so that the mobile communication terminal receives a wireless signal at the calculated time.
